(19) United States
(12) Patent Application Publication
(10) Pub. No.: US 2016/0276053 A1
(43) Pub. Date: Sep. 22, 2016

(54) STABLE POLY(3,4-ETHYLENEDIOXYTHIOPHENE) COMPOSITIONS AND ANIONIC STABILIZERS WITH LIMITED ACIDITY

(71) Applicants: ARKEMA FRANCE, Colombes (FR); CENTRE NATIONAL DE LA RECHERCHE SCIENTIFIQUE, Paris Cedex 14 (FR); UNIVERSITE DE BORDEAUX, Bordeaux (FR); INSTITUT POLYTECHNIQUE DE BORDEAUX, Talence Cedex (FR)

(72) Inventors: Christophe NAVARRO, Bayonne (FR); Wiljan SMAAL, Talence (FR); Muhammad MUMTAZ, Bordeaux (FR); Eric CLOUTET, Saint Caprais De Bordeaux (FR); Cyril BROCHON, Merignac (FR); Georges HADZIIOANNOU, Leognan (FR)

(73) Assignees: Arkema France, Colombes (FR); Centre National De La Recherche Scientifique (CNRS), Paris Cedex 14 (FR); Universite De Bordeaux, Bordeaux (FR); Institut Polytechnique De Bordeaux, Talence Cedex (FR)

(21) Appl. No.: 15/033,479

(22) PCT Filed: Oct. 29, 2014
(86) PCT No.: PCT/FR2014/052750

§ 371 Date: Apr. 29, 2016

(30) Foreign Application Priority Data
Oct. 31, 2013 (FR) 13.60684

(51) Int. Cl. H01B 1/12; C08L 81/02; H01B 1/24

(52) U.S. Cl. CPC H01B 1/127; H01B 1/24; C08L 81/02

(57) ABSTRACT

The invention relates to a stable composition of poly(3,4-ethylenedioxythiophene) anionic stabilizers with a limited degree of acidity.

The invention relates to a stable composition of poly(3,4-ethylenedioxythiophene) an ionic stabilizers with a limited degree of acidity.

Poly(3,4-ethylenedioxythiophene), known under the abbreviation PEDOT, is a polymer which was discovered in the laboratories of Bayer AG in Germany, in collaboration with the AGFA group, at the end of the 1980s. It is used in particular in organic electronic applications, especially in photovoltaic cells, but more generally in optoelectronic applications, on account of its good conductivity and in particular on account of its stability to oxidation and its transparency.

PEDOT is a polymer that is insoluble in the usual solvents. It is generally combined with a poly(styrene-co-styrene-sulfonic acid) (PSS) copolymer, which makes it possible to disperse it in water. PSS acts as a filler dopant, forming colloidal particles consisting of an entanglement of PSS chains linked to PEDOT, with a PEDOT-rich core covered with a PSS-rich crown. These particles are commercially available with different degrees of conductivity. PEDOT:PSS may be readily deposited in thin film form via common methods such as spin casting or by ink-jet printing. In many optoelectronic devices, the PEDOT:PSS layers are arranged between an electrode layer composed of indium tin oxide (ITO) and of a layer of an active organic material. PEDOT:PSS affords better functioning of the electrode, smoothes the rough ITO surface and consequently limits the short circuits, and it protects the active organic layer from free indium and oxygen, giving the system a prolonged lifetime.

Unfortunately, the very nature of the PEDOT:PSS composition has drawbacks. In particular, colloidal dispersions of PEDOT:PSS are highly acidic and are the potential cause of degradation of the adjacent layers. To counter this problem, it is necessary to replace PSS, which is very acidic, with another polyelectrolyte while at the same time maintaining the advantages of PEDOT:PSS, in particular the stability of the dispersion.

After numerous tests, the Applicant has discovered a family of polyanion (Pan) stabilizers that act as charge dopants, allowing very good stability of the colloidal dispersions with PEDOT, while at the same time limiting the acidity of these colloidal dispersions. The resulting films are both easy to manufacture and have good electrical conductivity and good mechanical properties.

### SUMMARY OF THE INVENTION

The invention relates to a PEDOT:polyanion composition in which the polyanion comprises monomers which correspond to formula I below:

### I:

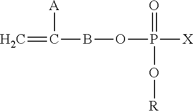 [0008] A=H, CH₃

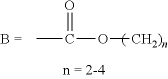

or aryl group
R=alkyl or aryl group

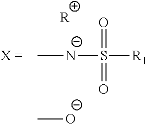

R1=CF₃, CH₃, F

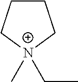

[symbol] = [symbol] , [symbol] , [symbol] (R′)₃,
   R′=aryl group

### DETAILED DESCRIPTION

The PAns used in the compositions of the invention are obtained by radical polymerization or by controlled radical polymerization of monomers I in the optional presence of ionic or nonionic comonomers.

The monomers optionally copolymerized with I are chosen from vinyl, vinylidene, diene, olefinic, allylic and (meth)acrylic monomers. These monomers are chosen more particularly from vinylaromatic monomers such as styrene or substituted styrenes, especially α-methylstyrene, acrylic monomers such as acrylic acid or salts thereof, alkyl, cycloalkyl or aryl acrylates such as methyl, ethyl, butyl, ethylhexyl or phenyl acrylate, hydroxyalkyl acrylates such as 2-hydroxyethyl acrylate, alkyl ether acrylates such as 2-methoxyethyl acrylate, alkoxy- or aryloxy-polyalkylene glycol acrylates such as methoxypolyethylene glycol acrylates, ethoxypolyethylene glycol acrylates, methoxypolypropylene glycol acrylates, methoxypolyethylene glycol-polypropylene glycol acrylates or mixtures thereof, aminoalkyl acrylates such as 2-(dimethylamino)ethyl acrylate (DAMEA), fluoro acrylates, silyl acrylates, phosphorous acrylates such as alkylene glycol phosphate acrylates, glycidyl or dicyclopentenyloxyethyl acrylates, methacrylic monomers such as methacrylic acid or salts thereof, alkyl, cycloalkyl, alkenyl or aryl methacrylates such as methyl methacrylate (MMA), lauryl, cyclohexyl, allyl, phenyl or naphthyl methacrylate, hydroxyalkyl methacrylates such as 2-hydroxyethyl methacrylate or 2-hydroxypropyl methacrylate, alkyl ether methacrylates such as 2-ethoxyethyl methacrylate, alkoxy- or aryloxy-polyalkylene glycol methacrylates such as methoxypolyethylene glycol methacrylates, ethoxypolyethylene glycol methacrylates, methoxypolypropylene glycol methacrylates, methoxypolyethylene glycol-polypropylene glycol methacrylates or mixtures thereof, aminoalkyl methacrylates such as 2-(dimethylamino)ethyl methacrylate (DAMEMA), fluoro methacrylates such as 2,2,2-trifluoroethyl methacrylate, silyl methacrylates such as 3-methacryloylpropyltrimethylsilane, phosphorous methacrylates such as alkylene glycol phosphate methacrylates, hydroxyethylimidazolidone methacrylate, hydroxy-ethylimidazolidinone methacrylate, 2-(2-oxo-1-imidazolidinyl)ethyl methacrylate, acrylonitrile, acrylamide or substituted acrylamides, 4-acryloylmorpholine, N-methylolacrylamide, methacrylamide or substituted methacrylamides, N-methylolmethacrylamide, methacrylamidopropyltrimethylammonium chloride (MAPTAC), glycidyl or dicyclopentenyloxyethyl methacrylates, itaconic acid, maleic acid or salts thereof, maleic anhydride, alkyl or alkoxy- or aryloxy-polyalkylene glycol maleates or hemi-maleates, vinylpyridine, vinylpyrrolidinone, (alkoxy) poly(alkylene glycol) vinyl ether or divinyl ether, such as methoxypoly(ethylene glycol) vinyl ether, poly(ethylene glycol) divinyl ether, olefinic monomers, among which mention may be made of ethylene, butene, hexene and 1-octene, diene monomers including butadiene, isoprene and fluoro olefinic monomers, and vinylidene monomers, among which mention may be made of vinylidene fluoride, or a combination of these monomers.

The polymerization of PAns is preferably performed by controlled radical polymerization, whether via nitroxides, RAFT (reversible addition fragmentation transfer) or ATRP (atom-transfer radical polymerization).

According to a first aspect of the invention, controlled radical polymerization is performed starting with alkoxyamines derived from the stable free radical (1).

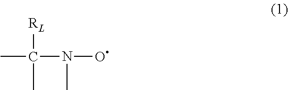

in which the radical R_{L} has a molar mass of greater than 15.0342 g/mol. The radical R_{L} may be a halogen atom such as chlorine, bromine or iodine, a linear, branched or cyclic, saturated or unsaturated hydrocarbon-based group such as an alkyl or phenyl radical, or an ester group —COOR or an alkoxy group —OR, or a phosphonate group —PO(OR)₂, provided that it has a molar mass of greater than 15.0342. The monovalent radical R_{L} is said to be in the β position relative to the nitrogen atom of the nitroxide radical. The remaining valency positions of the carbon atom and of the nitrogen atom in formula (1) may be bonded to various radicals such as a hydrogen atom, a hydrocarbon-based radical such as an alkyl, aryl or arylalkyl radical, comprising from 1 to 10 carbon atoms. It is not excluded for the carbon atom and the nitrogen atom in formula (1) to be linked together via a divalent radical, so as to form a ring. Preferably, however, the remaining valency positions of the carbon atom and of the nitrogen atom of formula (1) are linked to monovalent radicals. Preferably, the radical R_{L} has a molar mass of greater than 30 g/mol. The radical R_{L} may have, for example, a molar mass of between 40 and 450 g/mol. By way of example, the radical R_{L} may be a radical comprising a phosphoryl group, said radical R_{L} possibly being represented by the formula:

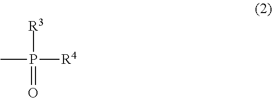

in which R³ and R⁴, which may be identical or different, may be chosen from alkyl, cycloalkyl, alkoxy, aryloxy, aryl, aralkyloxy, perfluoroalkyl and aralkyl radicals, and may comprise from 1 to 20 carbon atoms. R³ and/or R⁴ may also be a halogen atom such as a chlorine or bromine or fluorine or iodine atom. The radical R_{L} may also comprise at least one aromatic ring as for the phenyl radical or the naphthyl radical, the latter possibly being substituted, for example with an alkyl radical comprising from 1 to 4 carbon atoms.

More particularly, the alkoxyamines derived from the following stable radicals are preferred:
N-tert-butyl-1-phenyl-2-methylpropyl nitroxide,
N-tert-butyl-1-(2-naphthyl)-2-methylpropyl nitroxide,
N-tert-butyl-1-diethylphosphono-2,2-dimethylpropyl nitroxide,
N-tert-butyl-1-dibenzylphosphono-2,2-dimethylpropyl nitroxide,
N-phenyl-1-diethylphosphono-2,2-dimethylpropyl nitroxide,
N-phenyl-1-diethylphosphono-1-methylethyl nitroxide,
N-(1-phenyl-2-methylpropyl)-1-diethylphosphono-1-methylethyl nitroxide,
4-oxo-2,2,6,6-tetramethyl-1-piperidinyloxy,
2,4,6-tri-tert-butylphenoxy.

The alkoxyamines used in controlled radical polymerization must allow good control of the sequence of monomers. Thus, they do not all allow good control of certain monomers. For example, the alkoxyamines derived from TEMPO make it possible to control only a limited number of monomers, and this is likewise the case for the alkoxyamines derived from 2,2,5-trimethyl-4-phenyl-3-azahexane 3-nitroxide (TIPNO). On the other hand, other alkoxyamines derived from the nitroxides corresponding to formula (1), particularly those derived from the nitroxides corresponding to formula (2) and even more particularly those derived from N-tert-butyl-1-diethylphosphono-2,2-dimethylpropyl nitroxide, make it possible to broaden to a large number of monomers the controlled radical polymerization of these monomers.

In addition, the opening temperature of the alkoxyamines also has an influence on the economic factor. The use of low temperatures will be preferred to minimize the industrial difficulties. A preference will thus be given to alkoxyamines derived from the nitroxides corresponding to formula (1), particularly those derived from the nitroxides corresponding to formula (2) and even more particularly those derived from N-tert-butyl-1-diethylphosphono-2,2-dimethylpropyl nitroxide to those derived from TEMPO or 2,2,5-trimethyl-4-phenyl-3-azahexane 3-nitroxide (TIPNO).

According to a second form of the invention, the controlled radical polymerization takes place via RAFT, and more particularly with an RAFT agent corresponding to formula II below:

### II:

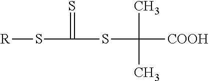

in which R represents an alkyl group comprising 1 to 22 carbon atoms, preferably 10 to 18 carbon atoms and more preferably 12 carbon atoms.

The PEDOT:PAn compositions that are the subject of the invention may be used for dispersing nanofillers, such as carbon nanotubes, whether they are single-walled or multi-walled, graphenes or silver nanoyarns. The films obtained with these compositions have good transparency and good conductivity. The compositions of the invention may also contain additives, in particular ethylene glycol.

### Example 1

Polymerization of potassium 4-styrenesulfonyl (trifluoro-methylsulfonyl) imide via RAFT with 2-(dodecyl-sulfanyl-thiocarbonyl-sulfanyl)-2-methylpropionic acid:

The synthesis of the monomer potassium 4-styrenesulfonyl (trifluoromethylsulfonyl)imide known as STFSIK is performed in accordance with the literature and is described in the article by R. Meziane et al., Electrochimica Acta, 2011, 57, 14-19.

The RAFT agent (2-(dodecyl-sulfanyl-thiocarbonyl-sulfanyl)-2-methylpropionic acid) is synthesized in accordance with the literature and is described in the article by J. T. Lai et al., Macromolecules, 2002, 35, 6754-6756.

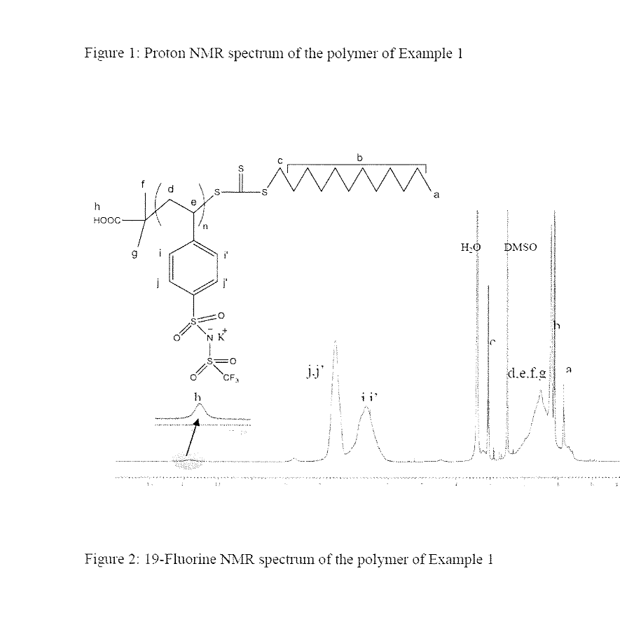

2 g (5.66 mmol) of potassium 4-styrenesulfonyl (trifluoro-methylsulfonyl)imide, 36.4 mg (0.1 mmol) of 2-(dodecyl-sulfanyl-thiocarbonyl-sulfanyl)-2-methylpropionic acid, 3.28 mg (0.02 mmol) of AIBN (azobisisobutyronitrile) and 4 ml of dimethylformamide (DMF) are placed in a dry Schlenk tube. The Schlenk tube is then rendered inert and placed in an oil bath at 65° C. After total conversion (24 hours), the Schlenk tube is immersed in liquid nitrogen. The polymer PSTFSIK (potassium poly(4-styrenesulfonyl (trifluoromethylsulfonyl)-imide)) is washed twice by precipitation and then filtration with ether. The polymer is then dried at 60° C. in an oven under vacuum. The structure of the polymer is confirmed by proton NMR (FIG. 1) and 19-fluorine NMR (FIG. 2).

The number-average molecular mass measured by SEC with polystyrene standards is 20 000 g/mol, and the polydispersity index is 1.1

### Example 2

### Polymerization of EDOT in the presence of PSTFSIK

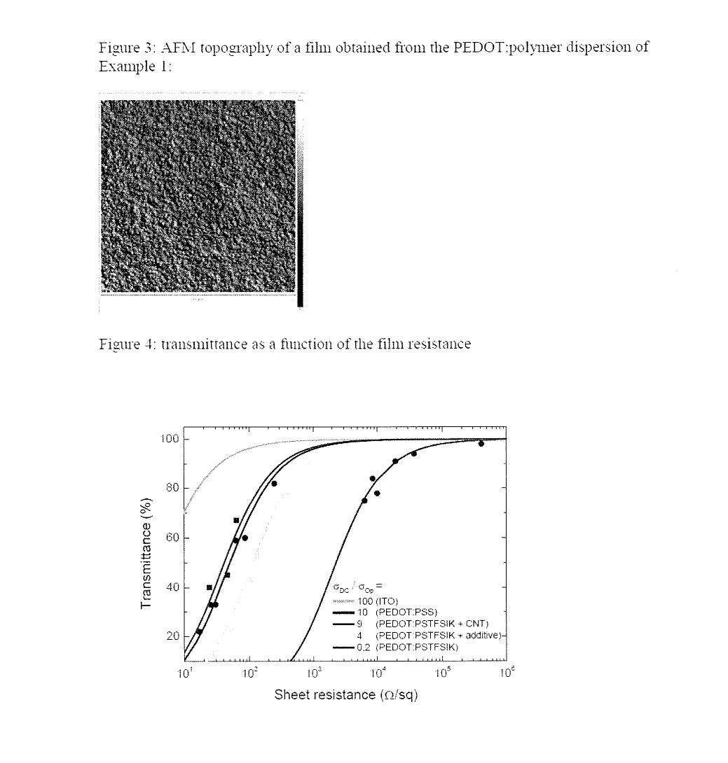

1.65 g (Mn 20 000 g/mol) of PSFTSIK dissolved in 150 ml of deionized water, 0.3 ml (2.81 mmol) of EDOT (Sigma-Aldrich) are placed in a one-necked round-bottomed flask with stirring. A mixture of ammonium persulfate (640 mg, 2.81 mmol) and ferric chloride (136 mg, 0.84 mmol) is then introduced. The reaction mixture is stirred vigorously for 48 hours, under a nitrogen atmosphere at 25° C. This gives a dark blue dispersion. The resulting dispersion of PEDOT and of PSTFSIK is washed by ultrafiltration with a regenerated cellulose Millipore membrane NMWL: 100 000 (molecular weight cutoff) in the presence of deionized water to remove the salts originating from the oxidizing agents and the PSTFSIK not bonded to PEDOT. The final yield of solid is 85%. A film is prepared with this dispersion by spin coating, and is subjected to AFM imaging. FIG. 3 shows the particle size, which ranges from 40 to 50 nm.

The PEDOT-polystyrene-co-polystyrene sulfonate latex prepared in Example 1 is compared with the commercial latex (PEDOT-polystyrene-co-polystyrene sulfonate).

These products are dispersed in deionized water (1% by mass) and subjected to shear using an IKA T18 Ultra-turrax blender, at various speeds (15 500, 20 000, 24 000 rpm) for 5 minutes for each speed.

Under these conditions, whether for the commercial latex or the latex that is the subject of the invention, it was not possible to observe the slightest agglomerate, demonstrating the very good stability of these two latices.

### Example 3

### Dispersion of Single-Walled Carbon Nanotubes in the Dispersion of Example 2

Graphistrength® multi-walled carbon nanotubes from the company Arkema are dispersed in water with the aid of the dispersion of Example 2 with powerful ultrasonic excitation for several minutes. The residual aggregates are removed by ultracentrifugation. Stable dispersions are observed for carbon nanotube concentrations of up to 0.15% by weight in an aqueous solution containing 0.26% by weight of the PEDOT:PSTFSIK couple.

### Example 4

### Conductivity of the Bulk PEDOT:PSTFSIK Couple

The electrical conductivity of samples of PEDOT:PSTFSIK is measured via the “4-probe” method on samples of pressed PEDOT:PSTFSIK in the form of disks 1 mm thick and 13 mm in diameter. The disks are obtained using a 10-tonne hydraulic press. The mass conductivities of these disks prepared under various synthetic experimental conditions are reported in Table 1.

TABLE 1
Mass conductivity
Oxidizing agent (mole ratio relative to the EDOT - 1:0.3
(APS/FeCl₃)), 25° C.

| | | Oxidizing | |
|---|---|---|---|
| | Mole ratio | agent | |
| | EDOT/STFSIK | (mole ratio | Conductivity |
| Medium | unit | vs EDOT) | (S/cm) |
| H₂O | 1/1 | 1:0.3 | 14.65 |
| | | (APS/FeCl₃) | |
| H₂O | 0.8/1 | 1:0.3 | 15.33 |
| | | (APS/FeCl₃) | |
| H₂O | 0.6/1 | 1:0.3 | 34.83 |
| | | (APS/FeCl₃) | |
| H₂O | 0.4/1 | 1:0.3 | 9.33 |
| | | (APS/FeCl₃) | |
| H₂O | 0.6/1 | 1.15 (APS) | Non- |
| | | | conducting |
| H₂O | 0.6/1 | 2.3 (FeCl₃) | Aggregations |
| H₂O | 0.6/1 | 2.3 | 22.33 |
| | | (Fe(OTs)₃) | |
| H₂O/IPA | 0.6/1 | 1:0.3 | Non- |
| (1/1) | | (APS/FeCl₃) | conducting |
| H₂O/EG | 0.6/1 | 1:0.3 | Non- |
| (1/0.1) | | (APS/FeCl₃) | conducting |

IPA: isopropyl alcohol
EG: ethylene glycol
APS: ammonium persulfate
Fe(OTs)₃: iron tosylate

The best conductivity is obtained with the APS/FeCl₃ oxidizing couple in a 1:0.3 ratio when the mole ratio of EDOT and STFSIK is 0.6:1. No conductivity is observed when the synthesis is performed either in a water/isopropanol mixture or in a water/ethylene glycol mixture.

### Example 5

### Conductivity of the PEDOT:PSTFSIK Couple and of the Dispersion of Carbon Nanotubes in the PEDOT:PSTFSIK Dispersion

Thin films of PEDOT:PSTFSIK are prepared by spray coating of the PEDOT:PSTFSIK dispersions with 10% by mass of ethylene glycol on a glass plate placed on a hotplate heated to 100° C. The resistance is measured via the 4-probe technique and the transmission is measured at 550 nm using a Shimadzu UV-Vis-NIR UV-3600 spectrophotometer.

In the same manner, thin films are manufactured from the dispersions containing carbon nanotubes as prepared in Example 3 and the conductivity and transmission are measured.

The plot of the curves will be found in FIG. 4.

The satisfactory behavior of the formulations containing carbon nanotubes (CNT) in comparison with PEDOT:PSS PH1000 from the company Clevios (noted PEDOT:PSS) will be noted in particular.

1. A PEDOT:polyanion composition in which the polyanion comprises monomers which correspond to formula I below:
I: 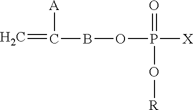
A=H, CH₃ 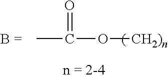
or aryl group
R=alkyl or aryl group 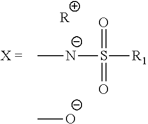
R1=CF₃, CH₃, F [symbol]
= [symbol] , [symbol] , [symbol] (R′)₃, 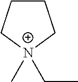
R′=aryl group

2. The composition as claimed in claim 1, in which the polyanion is prepared by controlled radical polymerization using a nitroxide.

3. The composition as claimed in claim 2, in which the nitroxide is N-tert-butyl-1-diethylphosphono-2,2-dimethylpropyl nitroxide.

4. The composition as claimed in claim 1, in which the polyanion is prepared by controlled radical polymerization using a RAFT agent.

5. The composition as claimed in claim 4, in which the RAFT agent corresponds to formula II below:
II: 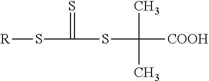
in which R represents an alkyl group comprising 1 to 22 carbon atoms.

6. The composition as claimed in claim 1, additionally comprising an additive.

7. The composition as claimed in claim 6, in which the additive is ethylene glycol.

8. A conductive transparent film obtained from a composition as claimed in claim 1.

9. A method of dispersing nanofillers, comprising using a composition as claimed in claim 1 as a dispersant.

10. The method as claimed in claim 9, wherein the nanofillers consist of carbon nanotubes.

11. A conductive transparent film obtained from a composition as claimed in claim 1 and carbon nanotubes.
